(19) United States
(12) Patent Application Publication
(10) Pub. No.: US 2026/0370742 A1
(43) Pub. Date: Nov. 19, 2026

(54) ELECTRONIC PRODUCT PROTECTIVE CASE

(71) Applicant: SHENZHEN LINGYI INNOVATION TECHNOLOGY CO., LTD, Shenzhen (CN)

(72) Inventors: Yanghui Zheng, Shenzhen (CN); Qiushun Liu, Shenzhen (CN)

(21) Appl. No.: 19/750,281

(22) Filed: Jul. 22, 2026

Related U.S. Application Data
(63) Continuation-in-part of application No. 19/011,930, filed on Jan. 7, 2025.
Application No. 19/011,930 is a continuation of application No. 18/625,302, filed on Apr. 3, 2024, now Pat. No. 12,224,787.

(30) Foreign Application Priority Data
Sep. 7, 2023 (CN) 202311152026.3

(51) Int. Cl. H04M 1/02; B32B 3/26; B32B 5/02; B32B 27/32; B32B 27/36; B32B 27/38

(52) U.S. Cl. CPC H04M 1/0203; B32B 3/266; B32B 5/02; B32B 27/32; B32B 27/36; B32B 27/38; B32B 2262/101; B32B 2307/208; B32B 2307/7376; B32B 2457/00

(57) ABSTRACT

An electronic product protective case is provided and includes at least one layer of first sheet material, at least one layer of second sheet material, and a film. The at least one layer of first sheet material, the at least one layer of second sheet material, and the film are sequentially stacked from an outside to an inside. The at least one layer of second sheet material defines a mounting hole, the at least one layer of first sheet material covers the mounting hole on an outer side of the at least one layer of second sheet material, a magnetic piece is embedded in the mounting hole, the film covers the mounting hole on an inner side of the at least one layer of second sheet material, and a thickness of the film is less than a thickness of the at least one layer of second sheet material.

### CROSS-REFERENCE TO RELATED APPLICATIONS

This is a continuation-in-part application of U.S. Application No. 19/011,930, filed Jan. 07, 2025, which is a continuation of U.S. patent application Ser. No. 18/625,302, filed on Apr. 3, 2024, which claims priority to Chinese Patent Application No. 202311152026.3, filed on Sep. 7, 2023, the entire contents of each of which are hereby incorporated by reference herein.

### FIELD OF THE DISCLOSURE

The present disclosure generally relates to the technical field of electronic device protection and, in particular, to an electronic device protective case.

### BACKGROUND

In order to facilitate magnetic charging, electronic equipment protective cases (e.g., cell phone cases) are increasingly embedded with magnetic pieces or components. Magnetic pieces have certain thickness, so in order to embed the magnetic pieces, a mobile phone case must have a certain thickness, which makes it difficult to make the mobile phone case thin.

One approach is to directly open a blind groove on the inner surface of the mobile phone case and to adhere the magnetic piece to the blind groove through glue or other methods. Although the mobile phone case made in this way looks thin and light, it can only be bent to a small extent because large scale bending will cause the exposed magnetic piece to be pushed out and fall out of the blind groove. Such as case does not meet the bending resistance performance required during the assembly process, or the installation or removal of the mobile phone case.

Additionally, in some methods of protective case fabrication, after the mobile phone case is embedded with a magnetic piece, a layer of flannel is attached, so that the magnetic piece will not fall out. However the use of a layer of flannel increases the thickness of the mobile phone case, causing it to look bulky. This choice of manufacturing is not the best choice for consumers desiring lighter and thinner mobile phone cases.

### SUMMARY

An electronic product protective case is provided and includes at least one layer of first sheet material, at least one layer of second sheet material, and a film. The at least one layer of first sheet material, the at least one layer of second sheet material, and the film are sequentially stacked from an outside to an inside. The at least one layer of second sheet material defines a mounting hole, the at least one layer of first sheet material covers the mounting hole on an outer side of the at least one layer of second sheet material, a magnetic piece is embedded in the mounting hole, the film covers the mounting hole on an inner side of the at least one layer of second sheet material, and a thickness of the film is less than a thickness of the at least one layer of second sheet material.

### BRIEF DESCRIPTION OF THE DRAWINGS

The above needs are at least partially met through provision of one, more than one, or any combination of the approaches for systems for containing and dispensing a cosmetic product described in the following detailed description, particularly when studied in conjunction with the drawings, wherein:

FIG. 1A illustrates an exploded view of an example electronic device protective case in accordance with various examples;

FIG. 1B illustrates a cross-sectional view of the example electronic device protective case of FIG. 1A in accordance with various examples;

FIG. 2 shows a manufacturing method of an example electronic device protective case in accordance with various examples;

FIG. 3 shows another manufacturing method of an example electronic device protective case in accordance with various examples;

FIG. 4A illustrates an exploded view of another example electronic device protective case in accordance with various examples;

FIG. 4B illustrates a cross-sectional view of the example electronic device protective case of FIG. 4A in accordance with various examples; and

FIG. 5 shows another manufacturing method of an example electronic device protective case in accordance with various examples.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various examples. Also, common but well-understood elements that are useful or necessary in a commercially feasible examples are often not depicted in order to facilitate a less obstructed view of these various examples. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various approaches, a case for protecting an electronic device is provided that is thin, light, and aesthetically pleasing. In some examples, the protective case may be waterproof and sweat-proof due to an outer coating on a decorative layer, as well as having a reduced overall thickness of the case and retaining a magnetic component in the case during insertion and removal of an electronic device by coating a functional layer, all which having the protective case be light and aesthetically pleasing. Methods of making such a protective case for an electronic device are also provided herein.

Summary of the reference numbers: 100 - smart phone protective case, D- decorative layer, F – functional layer, 1 - first sheet (part of the decorative layer), C1 – first coating film, 2 - second sheet (part of the functional layer), 20 - mounting hole, 3 - second coating film, 4 - magnetic piece (e.g., component), 5 - back plate, 6 - side frame, 7 - avoidance hole, 8 - camera ring.

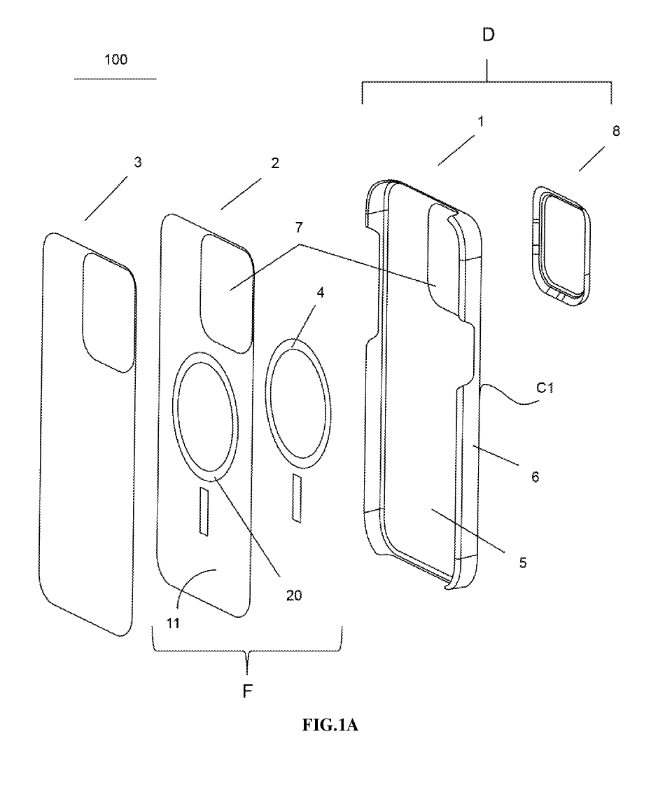

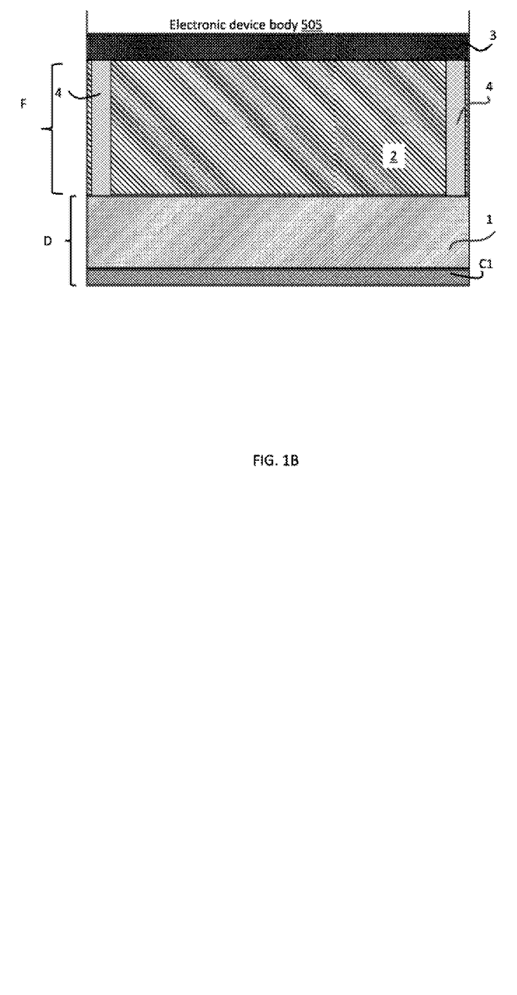

FIGS. 1A and 1B show an electronic device protective case, specifically a smart phone protective case (100), including from outside to inside a decorative layer (D) and a functional layer (F), wherein the decorative layer (D) includes at least one layer of a first sheet (1); the functional layer (F) includes at least one layer of second sheet (2) and a magnetic piece or component (4). The second sheet (2) includes a mounting hole (20). The magnetic piece (4) is embedded in the mounting hole (20), and the depth of the mounting hole (20) matches the thickness of the magnetic piece (4).

The outer surface of the decorative layer (D), which is the outer surface of the first sheet (1), may have a first coating (C1). The first coating (C1) may be obtained by spraying a surface treatment agent. By coating the outer surface of the decorative layer, the outer surface may be made waterproof and sweat-proof.

The inner surface (11) of the functional layer (F), which is the inner layer of the second sheet (2), is in contact with the second coating (3). The second coating (3) completely covers the mounting hole (20) and, in the version depicted, substantially completely covers the inner surface (11) of the functional layer (F). The second coating (3) is translucent, transparent, or semi-transparent in some versions, and may be made of at least one of polyester thin film, polyethylene film, polypropylene film, epoxy film, and any polymer film which can be created using spray coating technology, heat pressing, or coating or deposition techniques.

By coating the functional layer (F) with the second coating (3), the magnetic component (4) is prevented from easily being pushed out and detached due to the exposure of the magnetic component to the interface of the case with an electronic device. Additionally, such a coating of the functional layer (F) prevents the inner layer of the conventional mobile phone case from being too thick, and allows a thin, light, and aesthetically pleasing electronic device protective case to be obtained.

The material of the first coating (C1) may be any suitable surface treatment capable of achieving functions such as waterproof and sweatproof, anti-fingerprint, anti-scratch, and improved appearance, including an oily or water-based surface treatment agent such as oil based paint, hydrophobic paint, anti-fingerprint paint.

FIG. 1B shows a schematic of a cross-section of the electronic device protective case (100) shown in FIG. 1A. In FIG. 1B, a portion of an electronic device body (505) is shown adjacent to the protective case (100), the figure is representative of when the protective case (100) is in use. Adjacent to the electronic device body (505), is the second coating (3). The functional layer (F) is shown adjacent to or sandwiched between the second coating (3) and the decorative layer (D). The functional layer (F) includes the second sheet (2) and the magnetic component (4) fitted into the mounting hole (20), as shown in FIG. 1A. The decorative layer (D) includes the first sheet (1) and the first coating (C1).

In some embodiments, the functional layer (F) includes an outer shell defining an accommodating cavity and an opening in communication with the accommodating cavity, and the functional layer (F) may attract to an external device such as a mobile phone.

To manufacture the electronic device protective case, a coating plus spraying method can be used, such as a spray-painting method. Alternatively, or additionally, a hot press forming method can be used during manufacturing.

The spray coating method may include a spray-painting method including any of the following: air-atomized spray painting; airless spray painting; electrostatic spray painting; high-volume, low-pressure spray painting; and any combination thereof. The type of atomizer used in the spray coating method may include a spray nozzle and/or an ultrasonic atomizer. In some implementations, the spray coating method may be an additive one in which multiple types of spraying methods and/or materials are used. The spray coating method or process may be simpler and the cost is lower than other methods, such as hot pressing. Because inner and outer surfaces do not include too many grooves, gaps, protrusions and other similar structures, spray coating or spray painting is a suitable method for coating the inner and outer surfaces of smart phone cases. However, for shapes or configurations with many fine structures, it would not be easy to apply an evenly sprayed coating. When compared with directly applying film materials (e.g., using adhesive), this process may also allow for more flexible thickness control.

The coating plus spraying method may be used to prepare the first coating (C1) and the second coating (3) in some implementations. The spray coating method (e.g., coating plus spraying method) may be able to achieve a well-controlled coating thickness. The thickness of the first coating (C1) may range from about 0.01 mm to about 0.2 mm, such as from about 0.01 mm to about 0.15 mm, including from about 0.01 mm to about 0.1 mm. The thickness of the second coating (3) may range from about 0.01 mm to about 0.40 mm, such as from about 0.03 mm to about 0.3 mm, including from 0.05 mm to about 0.28 mm.

The second coating (3) may be formed of polyester film, preferably, the second coating (3) may be formed of thermoplastic polyurethane (TPU). TPU has flexible characteristic at room temperature after curing, the use of TPU can bring the following effects: (I) Because TPU is flexible, it can allow a certain degree of compression after the electronic equipment protective case is assembled, reducing the accuracy requirements for the thickness of the protective case. (II) TPU is soft and could absorb impact energy, thereby providing additional protection for the electronic device placed in the protective case.

The magnetic component (4) includes multiple magnet blocks. The magnetic component (4) may be placed on a polyimide film (PI film). The PI film may fit between the magnetic component (4) and the first sheet (1). In the assembled protective case for electronic device, one surface of the PI film is attached to the magnetic member (4), the other surface of the PI film is attached to the first sheet (1). The use of PI film can increase compatibility, prevent bubbles or hollows between the magnetic component (4) and the first sheet (1), and make the electronic device protective case smooth and flat. The size of the PI film can be designed to be slightly wider than the magnetic component (4). For example, the edge of the PI film protrudes from the outer edge of the magnetic component (4) by at least 1 mm. The PI film can also be dyed with black dye. After placing the magnetic component (4) on the dyed PI film, the PI film can cover the gaps between the magnetic blocks of the magnetic component (4) to improve the light-shielding effect, thereby avoiding light leakage at the location of magnetic component (4) in the electronic device protective case.

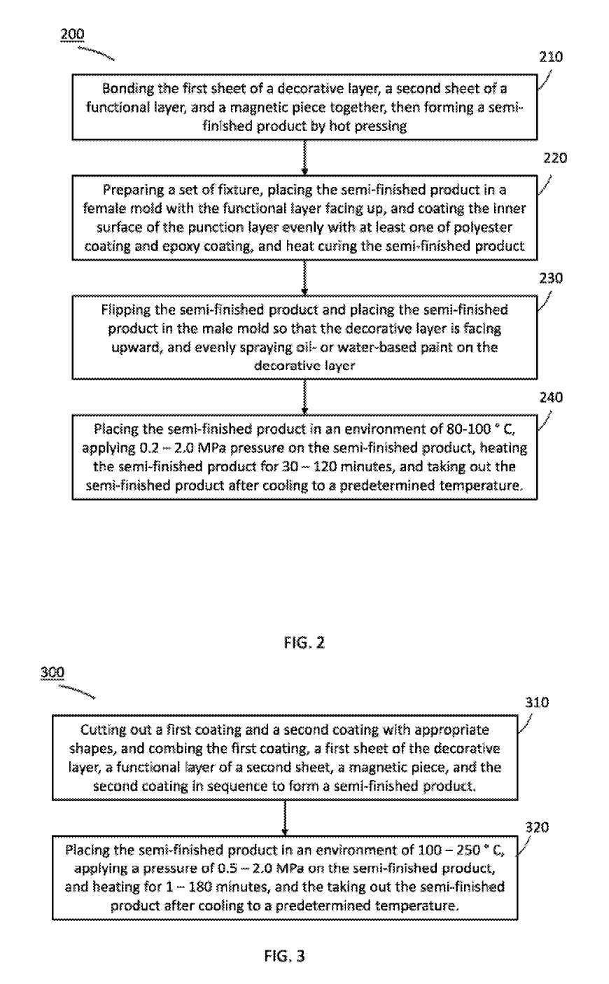

As shown in FIG. 2, the electronic device protective shell (100) may be constructed by a method (200) that includes the following steps.

In step 210, the method (200) includes bonding the first sheet (1) of the decorative layer (D), the second sheet of the functional layer (2) and the magnetic piece (4) together, and then forming a semi-finished product by hot pressing.

In step 220, the method (200) includes placing the semi-finished product in a female portion of a product mold with the functional layer (F) facing up and then coating the inner surface (11) of the functional layer (F) evenly with a material to form the second coating (3), and heat curing the semi-finished product. The coating material applied to the inner surface (11) to form the second coating (3) may be at least one of a polyester coating and an epoxy coating or a combination thereof.

In step 230, the method (200) includes flipping, or rotating, the semi-finished product and placing the semi-finished product in a male portion of a product mold so that the decorative layer (D) is facing upward, and evenly spraying a material on the decorative layer (D) to from the first coating (C1). The material sprayed on the decorative layer (D) may include oil- or water-based paint.

In step 240, the method (200) includes placing the semi-finished product in an environment of a predetermined temperature range and applying pressure in a predetermined range on the semi-finished product, heating the semi-finished products for a predetermined amount of time, then taking out the semi-finished product after cooling. The predetermined temperature range may be from about 70° C. to about 120° C., such as about 75° C. to about 110° C., including about 80 ° C. to about 100° C. The predetermined pressure may range from about 0.1 MPa to about 2.1 MPa, such as from about 0.15 MPa to about 2.05 MPa, including from about 0.2 MPa to about 2.0 MPa pressure on the semi-finished product. The predetermined temperature used for heating the semi-finished product while at the predetermined pressure may range from about 20 minutes to about 130 minutes, such as from about 25 minutes to about 125 minutes, including from about 30 minutes to about 120 minutes. Taking out the semi-finished product after cooling may including waiting until the semi-finished product reaches a predetermine temperature before removing it from the mold, such as waiting until the semi-finished product reaches ambient room temperature, or waiting until the semi-finished product reaches about 30° C. or below.

For the hot press forming method, the thickness of the first coating (C1) may range from about 0.01 mm to about 0.15 mm, including from about 0.02 mm to about 0.10 mm. When using this same method, the thickness of the second coating (3) may range from about 0.08 mm to about 0.30 mm, including from about 0.1 mm to about 0.28 mm. Using the hot pressing forming method to prepare the first coating (C1) and the second coating (3) is suitable when the inner and outer surfaces of the electronic device protective case have irregular or fine structures, such as concave, grooves, gaps, protrusions, and the like. The ability to apply high pressure with accuracy in high-temperature environments allows the first coating (C1) and the second coating (3) cover these irregular or fine structures well, without paint peeling, bubble forming, and/or bulging.

An electronic equipment protective case (100) may be fabricated using the hot press molding method (300) shown in FIG. 3.

In step 310, the method (300) includes cutting out the first coating (C1) and the second coating (3) with appropriate shapes, and combining the first coating (C1), the first sheet (1) of the decorative layer (D), the second sheet (2) of the function layer (F), the magnetic piece (4) and the second coating (3) in that sequence to form a semi-finished product.

In step 320, the method (300) includes placing the semi-finished product in an environment of a predetermined temperature, applying a predetermined pressure on the semi-finished product, and heating for a predetermined number of minutes, then taking out the semi-finished product after cooling. The predetermined temperature may range from about 80 ℃. to about 275 ℃., such as from about 90 ℃. to about 260 ℃., including from about 100 ℃. to about 250 ℃. The predetermined pressure may range from about .04 MPa to about 2.5 MPa, including from about 0.5MPa to about 2.0MPa. The predetermined number of minutes may range from about 1 minute to about 180 minutes.

Further, in some implementations, depending on the material, the heating time in step 320 can range from 1minute to about 5 minutes. When using the hot pressing fabrication method to create the first coating (C1) and the second coating (3), the second coating (3) may preferably be an epoxy film. When the second coating (3) is an epoxy film, the step 320 of the method may specifically include: placing the semi-finished product in an environment with a temperature ranging from about 100 ℃. to about 250 ℃., apply pressure ranging from about 0.5 MPa to about 2.0 MPa on the semi-finished product, heating for about 60 minutes to about 180 minutes, and taking out the semi-finished product after cooling.

The first sheet (1) may include an artificial fiber sheet (e.g., a sheet that includes one or more synthetic fibers) that is pre-impregnated with resin. Additionally, or alternatively, the first sheet (1) may include a natural fiber sheet. The thickness of the first sheet (1) of each layer may range from about 0.05 mm to about 0.5 mm, including from about 0.1 mm to about 0.4 mm. In some examples, the first sheet (1) may include a pre-impregnated aramid fiber sheet with a thickness ranging from about 0.25 mm to about 0.35 mm. In some examples, the first sheet (1) may include a pre-impregnated hemp fiber sheet with a thickness ranging from about 0.3 mm to about 0.4 mm. In producing protective cases for electronic devices, artificial fiber materials have properties that can be superior to ordinary polycarbonate (PC) and soft rubber materials. The advantageous materials properties of artificial fibers include low density, low weight, high strength, high modulus, as well as acid and alkali resistance. Using artificial fibers to fabricate the first sheet (1), may make the decorative layer stronger, wear-resistant, lighter, and thinner. Using natural fiber materials to fabricate the first sheet (1) would be more environmentally friendly. Whether synthetic fiber or natural fiber is used to make the first sheet (1), the fiber texture may look more fashionable.

Further, the second sheet (2) may be an artificial fiber sheet pre-impregnated with resin, and the functional layer may include at least two layers of artificial fiber sheets, and each layer of the second sheet (2) may have a thickness of about 0.1 mm to about 0.3 mm. An artificial fiber sheet may be light and thin, and by choosing to stack more than two layers of artificial fiber sheets, and then provide mounting holes (20), a depth equivalent to the thickness of the magnetic piece (4) may be obtained. Matching the thickness of the magnetic piece (4) and the depth of the mounting hole (20) can make the surface of the functional layer smooth and avoid leaving marks on the decorative layer (D) during the hot pressing process due to due to the height difference between the second sheet (2) and the magnetic piece (4). In some embodiments, the artificial fibers of the second sheet (2) may be at least one of glass fibers, aramid fibers (e.g., poly(p-phenylene terephthalamide) fibers, PPTA fibers), liquid crystal polymer fibers (LCP fibers), basalt fibers (BFs), carbon fibers, ultra high molecular weight polyethylene fibers (UHMWPE fibers), poly(p-phenylene benzobisoxazole) fibers (PBO fibers), or polyimide fibers (PI fibers). In some embodiments, the artificial fibers may be replaced by other materials such as thermoplastic polyurethane film (TPU film), etc., as long as they have good compatibility with the resin, and are thin and transparent.

Specifically, the type of material used for the second sheet (2) and the thickness of the second sheet (2) may be selected to accommodate the thickness of the magnetic piece (4). In some examples, the thickness of the magnetic piece may be about 0.35 mm, and the second sheet (2) can be formed by stacking and pressing a layer of glass fiber sheet pre-impregnated with resin and a layer of aramid fiber sheet pre-impregnated with resin. The second sheet (2) may have a thickness of 0.35 ± 0.2 mm. In this example, holes can be made in the second sheet to form the mounting hole (20), and the depth of the mounting hole (20) matches the thickness of the magnetic piece (4). Alternatively, in some examples, the second sheet (2) can also be made up of four layers of fiberglass sheets pre-impregnated with resin. When the four layers of fiberglass sheets are stacked and pressed, the second sheet (2) may have a thickness of 0.4 ± 0.2 mm, and in this example, a blind hole with a depth of 0.35 mm is opened up in the second sheet (2) and is used as the mounting hole (20). As in the other example, the depth of the mounting hole (20) matches the thickness of the magnetic piece (4). The structural strength requirements of the entire smartphone protective case (100) will also be considered when making decisions regarding the selection of material types, thicknesses, and number of layers for the second sheet (2).

Further, as shown in FIG. 1A, the decorative layer (D) includes a back plate (5) and a side frame (6) formed by inwardly extending from edge of the back plate (5).The back plate (5) and the second sheet (2) are both provided with avoidance holes (7) and equipped with a camera ring (8). In some examples of an electronic device protective case, the edge of the functional layer is evenly aligned with the edge of the side frame (6). In other examples, the edge of the functional layer (F) is evenly aligned with the edge of the back panel (5). Alternatively, or additionally, the edge of the second coating (3) may be evenly aligned with the edge of the side frame (6). Alternatively, the edge of the second covering film (3) may be evenly aligned with the edge of the back panel (5). The structural strength of the smart phone protective case (100) may be improved by altering the materials and/or configurations of the side frame (6), second covering film (3), and back panel (5).

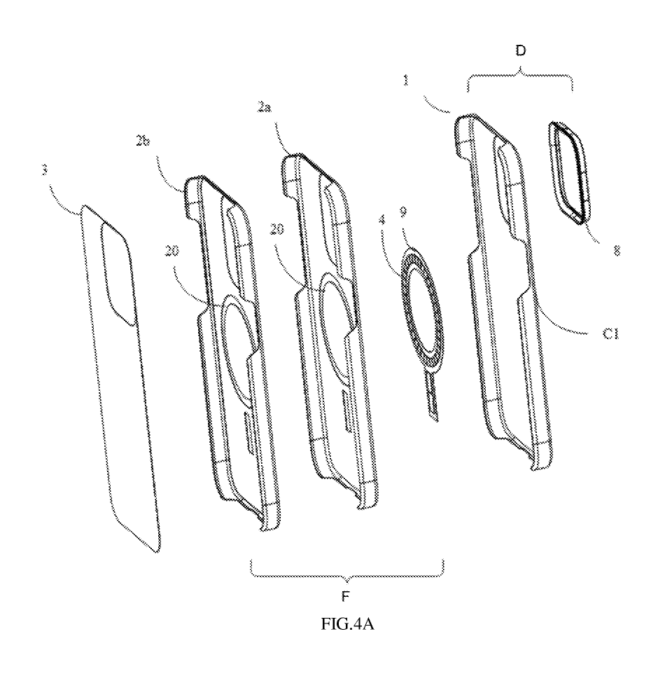

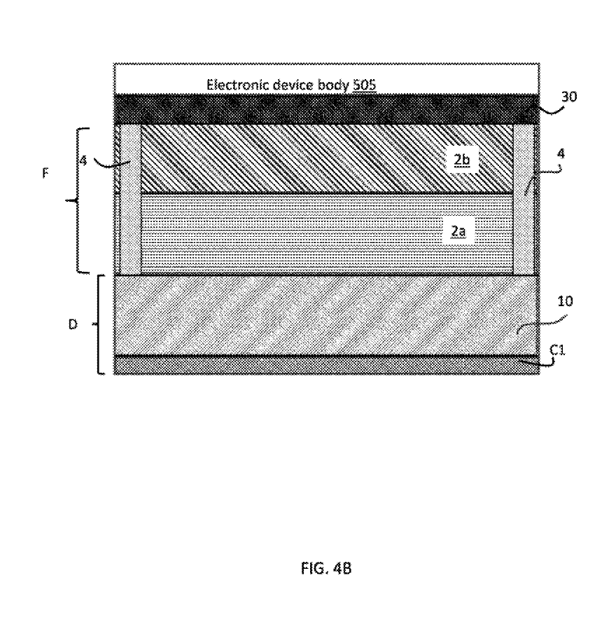

FIG. 4A shows an exploded view of another example of an electronic device protective case. FIG. 4B shows a cross section of a portion of the electronic device protective case shown in FIG. 4A. Shown in FIG. 4B is an electronic device body 505 adjacent to an electronic device protective case. The case has a decorative layer (D) and a functional layer (F). The decorative layer (D) includes a first coating (C1) and a first sheet (1). The first sheet (1) may be a first layer as described herein above, including an aramid fiber impregnated with epoxy resin. The first coating (C1) may also be like that described above, that is either cut from a layer or sprayed onto the first sheet (1) of the decorative layer (D). The functional layer (F) includes a magnetic piece (4) which is imbedded in a mounting hole (20). The functional layer (F) also has an interlayer of fabric (2a) and an interlayer of fiberglass (2b). The electronic device protective case also has a fiberglass lining layer (3) that is adjacent to the electronic device body (505) when the electronic device protective case is in use.

In some examples, the electronic device protective case shown in FIGS. 4A and 4B may have a decorative layer (D) that includes aramid fiber and epoxy resin. Additionally, or alternately, the fiberglass lining layer (3) may be a woven sheet of fiber glass impregnated with epoxy resin. The fiber glass lining layer (3) may include A-glass (alkali glass), C-glass (chemical glass), S-glass (structural glass), E-glass (electrical glass), or any suitable combination thereof. In addition to being a woven glass mat, the fiber glass lining layer (3) may include a chopped strand mat. The interlayer fabric (2a) in some examples may include an aramid fiber sheet impregnated with epoxy resin. Alternatively, or additionally, the interlayer fabric (2a) may include any suitable fiberglass or polymer fiber of suitable strength in torsion and compression as well as other desirable materials and/or mechanical characteristics such as shock absorption, temperature tolerance, and the like. The interlayer of fiberglass (2b) may be made of fiberglass impregnated with epoxy resin in some examples. The interlayer of fiberglass (2b) and the fiberglass lining (3) may be similar in composition, or they may be distinct. The interlayer of fiberglass (2b) and the fiberglass lining (3) may have the same materials (e.g., C-glass, E-glass, etc.) in different configurations or formats, such as different weaves or layups of the layers of fiber glass and including different densities of the fiberglass sheets. Further, the interlayer of fiberglass (2b) and the fiberglass lining (3) may utilize the same epoxy or distinct epoxy formulations.

It is noted that the fiberglass lining (3) have good compatibility with resin, and is thin.

For example, the fiberglass lining (3) may be a polyester film, and the polyester film includes at least one of a polyethylene terephthalate (PET) film, a polybutylene terephthalate (PBT) film, a polyester-type thermoplastic polyurethane (TPU) film, a polylactic acid (PLA) degradable polyester film, or a polycaprolactone (PCL) degradable polyester film. PET film has high production volume, a smooth surface, moderate hardness, and good adhesion. PBT film has good heat resistance and dimensional stability. Polyester-type TPU film has high elasticity, good adhesion, and excellent wear resistance. PLA degradable polyester film and PCL degradable polyester film are lightweight and environmentally friendly.

The fiberglass lining (3) may be a polyethylene film, and the polyethylene film includes at least one of low-density polyethylene (LDPE) ultra-thin cast film, linear low-density polyethylene (LLDPE) ultra-thin film, or high-density polyethylene (HDPE) film. LDPE ultra-thin cast film has a soft texture, good cushioning performance, and low cost. LLDPE ultra-thin film has good toughness and is not prone to cracking. HDPE film has high rigidity and good moisture barrier properties.

The fiberglass lining (3) may be a polypropylene film, and the polypropylene film includes at least one of a biaxially oriented polypropylene (BOPP) film, cast polypropylene (CPP) film, or ultra-thin porous polypropylene (PP) separator film. BOPP film is ultra-thin with high flatness and uniform thickness. CPP film has good heat-press adhesion. Ultra-thin porous PP separator film has good breathability.

The fiberglass lining (3) may be an epoxy resin thin layer, and the epoxy resin thin layer includes at least one of an epoxy resin-impregnated glass fiber thin layer, an epoxy resin-impregnated aramid fiber thin layer, an epoxy resin-impregnated carbon fiber thin layer, an epoxy resin-impregnated basalt fiber thin layer, or an epoxy resin-impregnated polyester fiber thin layer. Epoxy resin-impregnated glass fiber thin layer has high strength and dimensional stability. Epoxy resin-impregnated aramid fiber thin layer has high toughness, impact resistance, and lightweight properties. Epoxy resin-impregnated carbon fiber thin layer has ultra-high strength, lightweight construction, and good heat dissipation. Epoxy resin-impregnated basalt fiber thin layer has good chemical corrosion resistance, good weatherability, relatively low cost, and is environmentally friendly. Epoxy resin-impregnated polyester fiber thin layer has good flexibility and good compatibility.

The magnetic component (4) includes multiple magnet blocks. The magnetic component (4) may be placed on a polyimide film, PI film (9). The PI film (9) may fit between the magnetic component (4) and the first sheet (1).

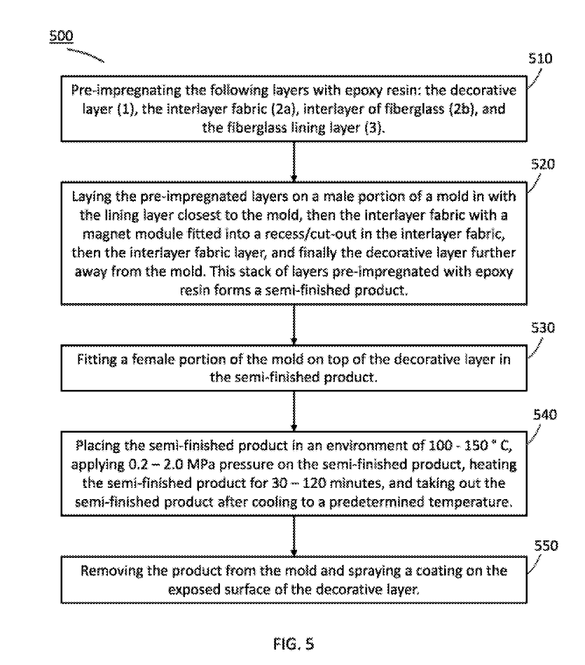

FIG. 5 shows a method of making an electronic device protective case such as the example case shown in FIGS. 4A and 4B. In the example method (500) shown in FIG. 5, the following layers are pre-impregnated with epoxy resin: the decorative layer (1), the interlayer fabric (2a), interlayer of fiberglass (2b), and the fiberglass lining layer (3) as in step 510. Step 520 includes laying the pre-impregnated layers on a male portion of a mold in with the lining layer closest to the mold, then the interlayer fabric with a magnet module fitted into a recess/cut-out in the interlayer fabric, then the interlayer fabric layer, and finally the decorative layer further away from the mold. In this way, the magnetic piece or magnet module is inlaid into the functional layer. This stack of layers, pre-impregnated with epoxy resin, forms a semi-finished product. The following step, step 530 may include fitting a female portion of the mold on top of the decorative layer in the semi-finished product. Placing the semi-finished product in an environment of about 100° C. to about 150° C., applying about 0.2 MPa to about 2.0 MPa pressure on the semi-finished product, heating the semi-finished product for about 30 minutes to about 120 minutes, and taking out the semi-finished product after cooling to a predetermined temperature may be part of the next step 540. Finally, as in step 550, the method may include removing the product from the mold and spraying a coating on the exposed surface of the decorative layer. The temperature, pressure, and time ranges described with respect to this example method may be approximate values, such that the environment in which the semi-finished product is placed may range from about 90° C. to about 200° C., such as from about 100 °C to about 175° C., including from about 100° C. to about 150° C. Further the pressure applied may range from about 0.10 MPa to about 2.50 MPa, such as about 0.15 MPa to about 2.25 MPa, including from about 0.10 MPa to about 2.00 MPa. Additionally, the time during which the heat is applied to the semi-finished product may range from about 20 minutes to about 180 minutes, such as from about 25 minutes to about 160 minutes, including from about 30 minutes to about 120 minutes.

Two examples of electronic device protection cases are provided below.

Example 1

The decorative layer (D) includes a layer of the first sheet (1). The functional layer (F) and the second coating (3) are aligned such that one edge of the functional layer and the second coating are evenly aligned with the edge of the side frame (6). A factor to consider in this example is that one layer of the first sheet (1) may be lighter and thinner, and in turn the side frame (6) is relatively fragile. In order to improve the structural strength and firmness during assembly of the case, a layer of second sheet (2) and/or the second coating (3) in the functional layer can be extended to the edge of the side frame (6). Preferably, the thickness of the back plate (5) is about 0.2 mm to about 0.4 mm, the thickness of the second coating (3) is about 0.05 mm to about 0.28 mm, thereby strengthening the overall structural strength.

Example 2

The decorative layer (D) includes a first sheet (1) that includes at least two layers. The edges of the functional layer (F) and second coating (3) are all evenly aligned. A factor to consider is that at least two layers of the first sheet (1) can improve the structural strength of the side frame (6), and also improve the firmness of the case during assembly, there is no need to extend the second sheet (2) or the second coating (3) to the side frame (6) in this example. Preferably, the thickness of the first sheet (1) is about 0.1 mm to about 0.25 mm and the first sheet (1) can be composed of two different types of sheets with different thicknesses. Such a choice of materials and configuration of the layers may be capable of balancing the relationship between the thickness of the decorative layer (D) and the structural strength.

The surfaces of the first coating (C1) and the second coating (3) can be smooth surfaces or rough surfaces. The first coating (C1) and the second coating (3) may be made of light-transmitting or semi-light-transmitting material, while the first sheet (1) may be made of opaque material. At least one layer of the second sheet (2) may be made of opaque material. Combined with the light-transmitting properties (e.g., transparency or semi-transparency) of the second coating (3), consumers can intuitively see the internal magnetic parts (4) through the second coating (3). For a technical and fashionable experience, a glossy surface on either, or both, the first coating (C1) or the second coating (3) can enhance the mirror feel, while a rough surface can enhance the feel.

More preferably, the smart phone protective case (100) may have at least two layers of sheets of opaque material, for example, the first layer of the first sheet (1) and the outermost layer of the second sheet (2) may both be made of opaque material, and this can prevent the corners of the phone case from transmitting light which may cause cosmetic defects.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises …a”, “has …a”, “includes …a”, “contains …a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

The patent claims at the end of this patent application are not intended to be construed under 35 U.S.C. § 112(f) unless traditional means-plus-function language is expressly recited, such as “means for” or “step for” language being explicitly recited in the claim(s).

What is claimed is:

1. An electronic product protective case, comprising at least one layer of first sheet material, at least one layer of second sheet material, and a film; wherein the at least one layer of first sheet material, the at least one layer of second sheet material, and the film are sequentially stacked from an outside to an inside;
the at least one layer of second sheet material defines a mounting hole, the at least one layer of first sheet material covers the mounting hole on an outer side of the at least one layer of second sheet material, a magnetic piece is embedded in the mounting hole, the film covers the mounting hole on an inner side of the at least one layer of second sheet material, and a thickness of the film is less than a thickness of the at least one layer of second sheet material.

2. The electronic product protective case according to claim 1, wherein the at least one layer of second sheet material comprises two layers of second sheet material, and the thickness of the film is less than a thickness of each of the two layers of second sheet material.

3. The electronic product protective case according to claim 2, wherein the two layers of second sheet material are a layer of a glass fiber sheet pre-impregnated with resin and a layer of an aramid fiber sheet pre-impregnated with resin that are stacked, and the aramid fiber sheet is located on a side of the glass fiber sheet away from the at least one layer of first sheet material.

4. The electronic product protective case according to claim 1, wherein the film completely covers the mounting hole

5. The electronic product protective case according to claim 1, wherein the film is a polyester film, and the polyester film comprises at least one of a polyethylene terephthalate (PET) film, a polybutylene terephthalate (PBT) film, a polyester-type thermoplastic polyurethane (TPU) film, a polylactic acid (PLA) degradable polyester film, or a polycaprolactone (PCL) degradable polyester film.

6. The electronic product protective case according to claim 1, wherein the film is a polyethylene film, and the polyethylene film comprises at least one of low-density polyethylene (LDPE) ultra-thin cast film, linear low-density polyethylene (LLDPE) ultra-thin film, or high-density polyethylene (HDPE) film.

7. The electronic product protective case according to claim 1, wherein the film is a polypropylene film, and the polypropylene film comprises at least one of a biaxially oriented polypropylene (BOPP) film, cast polypropylene (CPP) film, or ultra-thin porous polypropylene (PP) separator film.

8. The electronic product protective case according to claim 1, wherein the film is an epoxy resin thin layer, and the epoxy resin thin layer comprises at least one of an epoxy resin-impregnated glass fiber thin layer, an epoxy resin-impregnated aramid fiber thin layer, an epoxy resin-impregnated carbon fiber thin layer, an epoxy resin-impregnated basalt fiber thin layer, or an epoxy resin-impregnated polyester fiber thin layer.

9. The electronic product protective case according to claim 1, wherein the thickness of the film ranges from 0.05 mm to 0.28 mm or from 0.10 mm to 0.28 mm.

10. The electronic product protective case according to claim 1, wherein the at least one layer of first sheet material comprises a back plate and a side frame formed by an edge of the back plate extending inwardly; an edge of the at least one layer of second sheet material and an edge of the side frame are evenly aligned, and an edge of the film and the edge of the back plate are evenly aligned.

11. The electronic product protective case according to claim 1, wherein a difference between a thickness of the at least one layer of second sheet material and a thickness of the magnetic piece is 0.2 mm.

12. The electronic product protective case according to claim 1, wherein the mounting hole is a through hole penetrating the at least one layer of second sheet material.

13. An electronic product protective case, comprising:
a sheet material, defining a mounting hole, and arranged with a magnetic piece embedded in the mounting hole; and
a film, comprising a glass fiber sheet pre-impregnated with epoxy resin, covering the magnetic piece on an inner side of the sheet material, and fixed to the sheet material through the epoxy resin.

14. The electronic product protective case according to claim 13, wherein the sheet material comprises at least one layer of first sheet material and at least one layer of second sheet material, and the at least one layer of first sheet material and the at least one layer of second sheet material are sequentially stacked from an outside to an inside;
the film covers the magnetic piece on an inner side of the at least one layer of second sheet material;
the at least one layer of first sheet material comprises a glass fiber sheet material pre-impregnated with epoxy resin or an aramid fiber sheet material pre-impregnated with epoxy resin, and covers the magnetic piece on a side of the at least one layer of second sheet material away from the film.

15. The electronic product protective case according to claim 14, wherein the at least one layer of second sheet material comprises a layer of a glass fiber sheet pre-impregnated with resin and a layer of an aramid fiber sheet pre-impregnated with resin that are stacked, and the aramid fiber sheet is located on a side of the glass fiber sheet away from the at least one layer of first sheet material.

16. The electronic product protective case according to claim 14, wherein the film has light-transmissive properties, and the mounting hole is a through hole penetrating the at least one layer of second sheet material.

17. The electronic product protective case according to claim 14, wherein the at least one layer of first sheet material comprises a back plate and a side frame formed by an edge of the back plate extending inwardly; an edge of the at least one layer of second sheet material and an edge of the side frame are evenly aligned, and an edge of the film and the edge of the back plate are evenly aligned.

18. The electronic product protective case according to claim 13, wherein the glass fiber sheet of the film comprises at least one of alkali glass, chemical glass, structural glass, or electrical glass.

19. The electronic product protective case according to claim 13, wherein the film completely covers the mounting hole, and the thickness of the film ranges from 0.05 mm to 0.28 mm or from 0.10 mm to 0.28 mm.

20. The electronic product protective case according to claim 13, wherein the magnetic piece comprises a plurality of magnetic blocks, and the plurality of magnetic blocks are arranged in a ring.
